(19) United States
(12) Patent Application Publication
(10) Pub. No.: US 2013/0175227 A1
(43) Pub. Date: Jul. 11, 2013

(54) Method of Processing Biological Culturing Water by Using Active Photocatalytic Reactor

(71) Applicants: Din Ping Tsai, Hsinchu City (TW); Hung Ji Huang, Hsinchu City (TW); Chun-Ting Lin, Hsinchu City (TW)

(72) Inventors: Din Ping Tsai, Hsinchu City (TW); Hung Ji Huang, Hsinchu City (TW); Chun-Ting Lin, Hsinchu City (TW)

(73) Assignee: National Applied Research Laboratories, Taipei City (TW)

(21) Appl. No.: 13/343,754

(22) Filed: Jan. 5, 2012

(51) Int. Cl. C02F 1/32; B01J 37/34

(52) U.S. Cl. 210/748.14

(57) ABSTRACT

The present invention uses an active photocatalytic reactor to process biological culturing water. The process is accelerated. Water used in a biological culturing system is stabilized with pollutant in the water reduced. The active photocatalytic reactor is less affected by outside environment while having faster activating speed. The active photocatalytic reactor can be combined with a traditional filter to form a serial or parallel connection for more effectively purifying the culturing water with damage to the whole system avoided.

### TECHNICAL FIELD OF THE INVENTION

The present invention relates to processing culturing water; more particularly, relates to processing culturing water by using a photocatalytic reactor for obtaining stable water to be used in a biological culturing system.

### DESCRIPTION OF THE RELATED ARTS

More and more CO₂ is discharged in recent years and greenhouse effect on earth is thus become serious. Some studies are revealed concerning solutions of using semiconductor photocatalysts like TiO₂, SiC, GaP, etc. to reduce CO₂ with products like HCHO, CH₃OH, etc. by processing photocatalytic reduction reactions. In the reactions coordinated with slurry bed reactors, photocatalyst particles are uniformly mixed with reactant solutions to effectively process photocatalytic reduction reactions. The system used for such a reaction has high performance, but the photocatalyst has to be recycled and the procedure becomes complex with increased reaction time and cost. In addition, the photocatalyst needs to have enough illuminated area for mass-productive optical catalysis reaction. Because TiO₂ has a high shielding ratio to light, ultra-violet (UV) light only has a transmission thickness of 1-2 centimeters (cm) in a TiO₂-suspending gel solution, where TiO₂ located farer than 1-2 cm in water is not effectively reacted and processing efficiency of incident light is thus greatly diminished if not absorbed and used by the TiO₂ particles. In 1977, Marinangeli and Ollis revealed a fiber photocatalytic reactor. Therein, TiO₂ photocatalyst is adhered on a surface of a glass optical fiber. Reactants are contacted with a surface of the TiO₂ film and light is transferred in the optical fiber. Thus, the TiO₂ photocatalyst absorbs the propagating incident light and processes a photocatalytic reaction to the material adjacent. In U.S. Pat. Nos. 5,875,384, 5,919,422 and 6,238,630, a TiO₂-coated fiber optic cable reactor uses a LED or a lamp as a light source to obtain a high processing performance with a small-sized reactor. However, the TiO₂-coated fiber optic cable reactor is fixed in a reaction chamber and a low mass transfer rate of reactant to the surface of TiO₂ photocatalyst results in low processing efficiency.

In U.S. Pat. Nos. 5,480,524, 5,308,458, 5,689,798 and scientific research results presented by H. C. Yatmaz et al. (Chemosphere 42 (2001) 397±403), a rotating-bed reactor uses centrifugal force to increase mass transfer rate and reaction performance of reactant. With a light source is at outside of a reactive area, a photocatalytic reduction reaction has a bad performance under a situation of low penetrating rate of light. A photocatalytic reactor with movable conformal light guide plate (U.S. Pat. No. 7,927,553) can be used to accelerate photocatalytic reaction. In U.S. patent Ser. No. 12/913,212, a compound material capable of expanding light absorption range of original constitutional material successfully implants TiO₂ on a plastic substrate. This can be used to fabricate a photocatalytic optical disk for reducing organic pollutants in water solution.

For intensive farming of land animals or sea animals, culturing water is very important. In U.S. Pat. Nos. 7,407,793 and 7,407,793, nitrifying bacteria are used to reduce ammonium or nitrogen organic contaminations in water. As revealed in U.S. Pat. No. 7,351,527, virus in water has to be diminished and isolated to ensure health of Cyprinus carpio on culturing. Prior arts of floating island planter and water cycling and filtering system are used to filter out ammonium or nitrogen contaminations in water. As revealed in U.S. Pat. Nos. 7,241,373, 7,052,600 and 7,018,543, electrochemical methods are used to reduce organic pollutant in water.

Besides, on culturing artiodactyls and birds, volatile of fermented liquid, gas or solid excrements may cause serious pollution. Through proper washing process, some materials in the excrements can be dissolved in water and most part of harmful components is largely diminished through photocatalytic reaction.

On diminishing organic pollution, photocatalyst can play an important role. In U.S. Pat. Nos. 6,531,100 B1, 5,736,055, 6,238,631 B1, 6,932,947 B2 and 7,230,255 B2, various kinds of photocatalysts are revealed for purifying water. However, fixed-bed reactors still have low efficiency even using methods revealed in U.S. Pat. No. 4,956,754 and No. 6,547,963 B1 for increasing reaction effects by increasing staying time of liquids in photocatalytic reacting areas and by increasing time for stirring liquids. In an intensive farming system (especially for aquaculture), a great amount of pollution may be produced by too much animal feed, ever-changing temperature or sudden increase in bacteria. Nevertheless, pollutant density in discharged sewage for culturing land animals is extremely high to cause in environment pollution and disgusting smell.

Hence, the prior arts do not fulfill all users' requests on actual use.

### SUMMARY OF THE INVENTION

The present invention is an extended application of green technologies like chemical engineering, environmental engineering, aquaculture engineering, etc. By using an active photocatalytic reactor, culturing water is treated quickly with high efficiency to achieve more stability in a biological culturing system. The active photocatalytic reactor comprises a UV lamp source, a photocatalyst, a photocatalyst carrier and a photocatalyst carrier motion activator. The active photocatalytic reactor can be a spin-disk reactor (U.S. Pat. No. 7,927,553); a Taylor-vortex reactor with co-spindle tubes (U.S. Pat. Nos. 5,790,934 and 7,507,370); a vibrating reactor (Japan patent No. WO 03/037504 A1); or a rotating-fin reactor (U.S. Pat. No. 7,704,465 B2). The photocatalyst must be fixed on the photocatalyst carrier and, thus, the photocatalyst carrier can drive the photocatalyst to do various motions as being motivated by extra motivator or self movement. However, typical slurry-bed and fixed-bed reactors use different mechanisms. In a typical slurry-bed reactor, photocatalyst particles are homogeneously suspended in water with dissolved pollutants. The photocatalyst particles and water may drive in the same motion. In a fixed-bed reactor, the photocatalyst is only fixed on the stilled carrier and processes pollutants in water around the photocatalyst itself.

The active photocatalytic reactor can be combined with an extra filter to greatly reduce influence from outer environment, to more effectively purify culturing water, and to further avoid damage of the whole system.

The main purpose of the present invention is to use an active photocatalytic reactor to process culturing water, where the active photocatalytic reactor saves energy and has high performance on fast processing the culturing water to be used in a biological culturing system.

The second purpose of the present invention is to use various motions of photocatalyst carrier and photocatalyst to increase mass transfer rate of pollutants in water, where an operational efficiency of the photocatalyst is greatly speeded up on processing the culturing water as compare to the typical slurry-bed or fixed-bed reactor.

The third purpose of the present invention is to use the active photocatalytic reactor to reduce the pollutants in solid or gas phase with a water-washing pretreatment, where the processing functional of the active photocatalytic reactor is expended.

The fourth purpose of the present invention is to carry on the active photocatalytic reactor with various light source under miner modification, where the solar light can be an activating light source for photocatalytic pollutant elimination reaction in area of sufficient sun-light; and the light emitting diode (LED) can also be the light source to induce or assist the photocatalytic process.

The fifth purpose of the present invention is to flexibly assemble the active photocatalytic reactor with other utilities for fitting local environment and reaching an optimized operational convenience.

The active photocatalytic reactor used for maintaining culturing water is embedded in an intensive farming system to stabilize water quality and reduce waste water. The active photocatalytic reactor can be used to replace a purification utility or to coordinate with a traditional purification utility.

To achieve the above purposes, the present invention is a method of processing biological culturing water by using an active photocatalytic reactor, where the method uses a system comprising a biological culturing system and a culturing-water waste reduction system; the culturing-water waste reduction system contains an active photocatalytic reactor with or without typical filtering system; a culturing water is inputted into the active photocatalytic reactor of the culturing-water waste reduction system to reduce pollutants in the culturing water; the pollutants can be a compound or a combination of the compounds selected from NH₄, NH₃, NH₂ and NH; and, after purifying the culturing water, the culturing water is discharged or recycled back to a biological culturing system. Accordingly, a novel method of processing biological culturing water by using an active photocatalytic reactor is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1A is the view showing the first preferred embodiment according to the present invention;

FIG. 1B is the view showing the state-of-use of the active photocatalytic reactor;

FIG. 2 is the view showing the reaction products of ammonia and ammonium chloride;

FIG. 3 is the view showing the second preferred embodiment; and

FIG. 4 is the view showing the third preferred embodiment.

### DESCRIPTION OF THE PREFERRED EMBODIMENTS

The following descriptions of the preferred embodiments are provided to understand the features and the structures of the present invention.

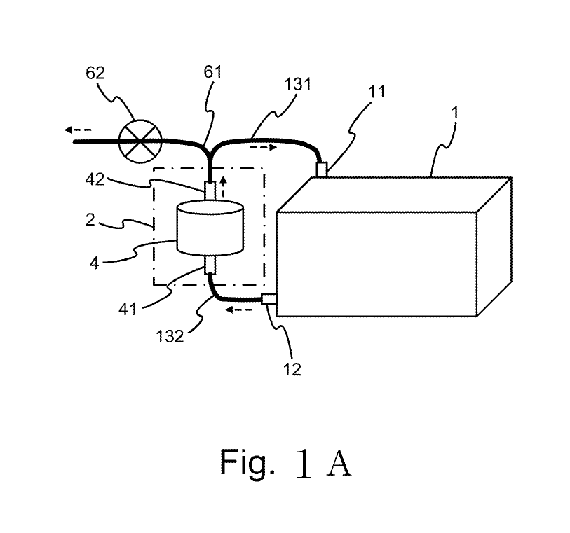

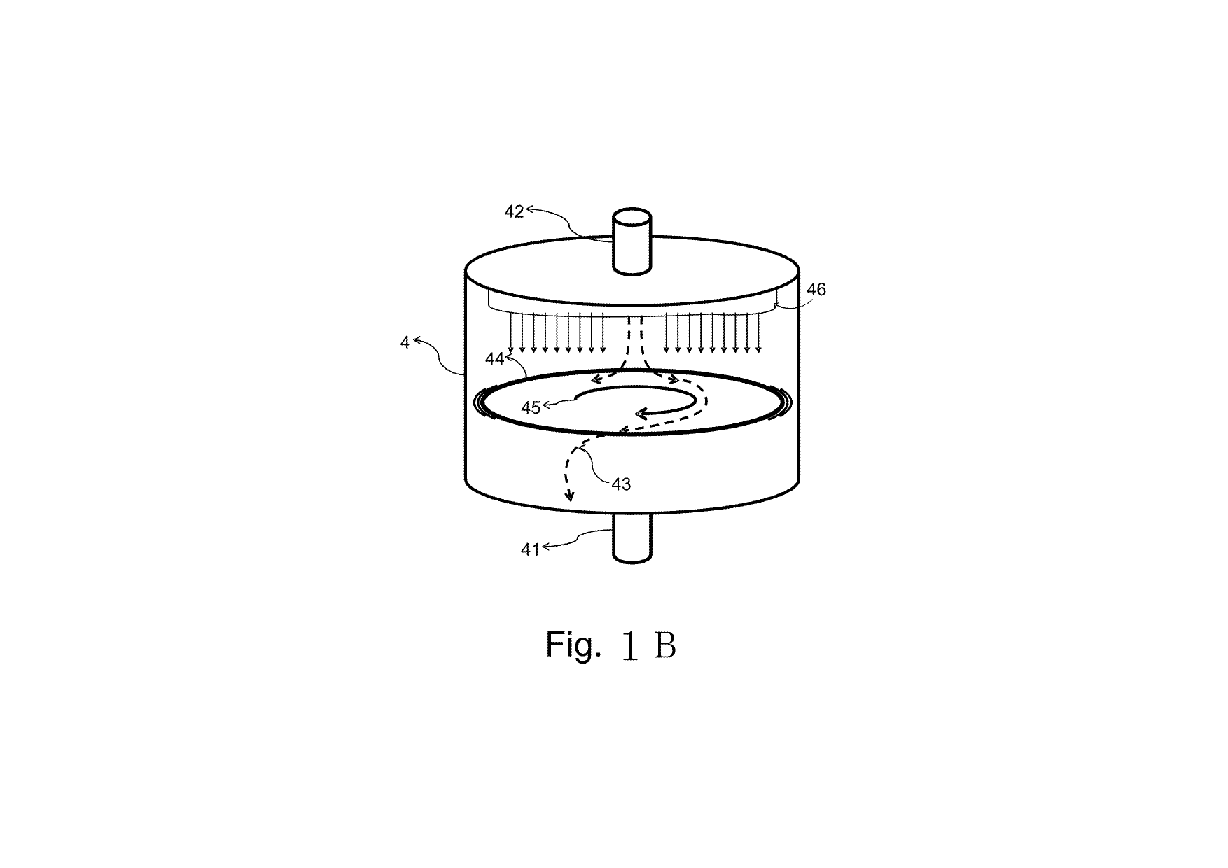

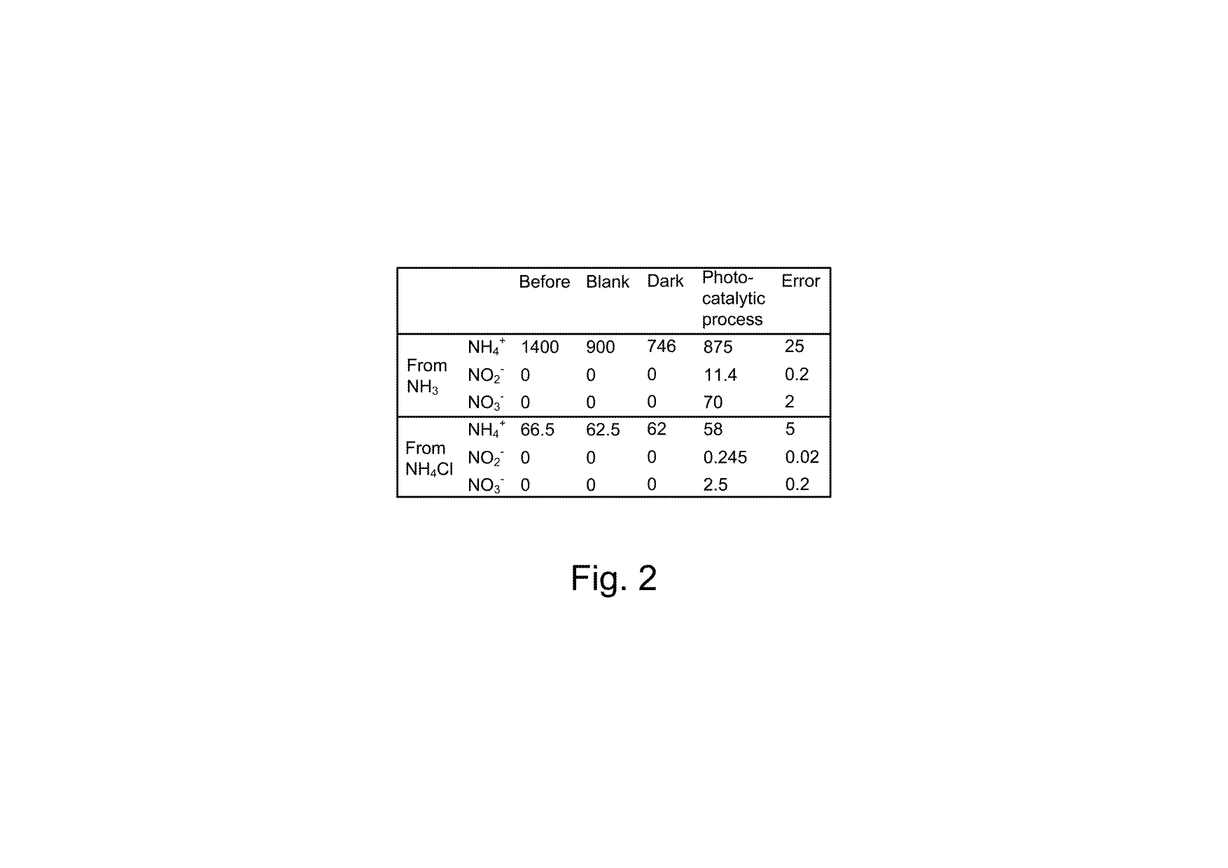

Please refer to FIG. 1A, FIG. 1B and FIG. 2, which are a view showing a first preferred embodiment according to the present invention; a view showing a state-of-use of an active photocatalytic reactor; and a view showing reaction products of ammonia and ammonium chloride. As shown in the figures, the present invention is a method of processing biological culturing water by using an active photocatalytic reactor. The present invention uses an apparatus comprising a biological culturing system 1 and a culturing-water waste reduction system 2 connected with the biological culturing system 1, where the culturing-water waste reduction system 2 contains an active photocatalytic reactor 4; the biological culturing system 1 has a culture system inlet 11 and a culture system outlet 12; the active photocatalytic reactor 4 has a photocatalytic reactor inlet 41 and a photocatalytic reactor outlet 42; the culture system inlet 11 is connected with the photocatalytic reactor outlet 42 through a first cycling route 131; the culture system outlet 12 is connected with the photocatalytic reactor inlet 41 through a second cycling route 132; and the photocatalytic reactor outlet 42 is connected with a draining tube 61 having a control valve 62.

The active photocatalytic reactor 4 has different inner structures for different forms, comprising an ultra-violet (UV) lamp 46, a photocatalyst disk 44, and a photocatalyst carrier motion activator 45. With a spin-disk reactor, culturing water 43 enters into the active photocatalytic reactor 4 through the photocatalytic reactor inlet 41 to be directed to a surface of the photocatalyst disk 44. The photocatalyst disk 44 is driven by the photocatalyst carrier motion activator 45 to rotate for uniformly distributing the culturing water 43 on the surface of the photocatalyst disk 44. By activating activity of a photocatalyst on the surface of the photocatalyst disk 44 through irradiation of the UV lamp source 46, pollution in the culturing water 43 is reduced. When excessive portion of the culturing water 43 is accumulated on the surface of the photocatalyst disk 44, a part of the culturing water 43 leaves the surface of the photocatalyst disk 44 owing to centrifugal force and is collected in the active photocatalytic reactor 4 to be directed to the photocatalytic reactor outlet 42 and outputted out of the active photocatalytic reactor 4.

Thus, the culturing water of the biological culturing system 1 is transferred to the photocatalytic reactor inlet 41 of the active photocatalytic reactor 4 from the culture system outlet 12 through the second cycling route 132 for purifying a compound or a combination of the compounds in the culturing water, where the compound is NH₄, NH₃, NH₂ or NH. The culturing water has a pH value maintained between 6 and 8 for operation. Then, the purified culturing water is transferred to the culture system inlet 11 from the photocatalytic reactor outlet 42 through the first cycling route 131 to be used in the biological culturing system 1. The above processes are kept on repeating, where the culturing water is outputted to the active photocatalytic reactor 4 and then are inputted into the biological culturing system 1 from the active photocatalytic reactor 4.

The biological culturing system 1 is a culture system for land- and aqua-biological intensive farming. According to waste produced, the system can be a closed one or a semi-closed one. For example, if the produced waste is solid or gaseous, water washing is processed at first to dissolve pollutant into water and then the water is directed to the outwardly connected culturing-water waste reduction system 2. If the waste produced is liquid and contains big solid particles, the waste is filtered around the time when being directed to the culture system outlet 12 (i.e. before entering into the photocatalytic reactor inlet 41) to avoid damaging different type of the photocatalyst carrier in the active photocatalytic reactor 4 or removing photocatalyst fixed on the active photocatalytic reactor 4.

The culturing-water waste reduction system 2 is used to purify the culturing water or waste water for recycle; or is discharged through the draining tube 61 with the control valve 62 and entered into a waste water processing system for processes followed.

The active photocatalytic reactor 4 can be a spin-disk reactor for speeding-up photocatalytic pollutant-reducing oxidation for ammonia in water, where ammonium ions from two different kinds of sources are both effectively diminished.

The spin-disk active photocatalytic reactor 4 processes the photocatalytic pollutant-reducing oxidation for ammonia in water. A syringe pump injects a diluted water solution having ammonium ions on a spin disk irradiated by two 4 watt (W) low-pressure mercury tube lamps, where the spin disk has a self-rotating speed of 300 revolutions per minute (rpm) and the diluted water solution has an injecting speed of 2 milliliter per minute (mL/min). The spin disk is adhered with a TiO₂ photocatalyst on surface and the TiO₂ photocatalyst is activated by a 254 nanometers (nm) UV light to oxidize ammonia in water into nitrite and nitrate. The first kind of ammonium ions is come from a water solution of ammonia gas; and the second kind of ammonium ions is come from a water solution of ammonium chloride.

In FIG. 2, 1400±25 milligrams per liter (mg/L) of the first kind of ammonium ions is reduced to 875±25 mg/L and is transformed into 11.4±0.02 mg/L of nitrate and 70±1 mg/L of nitrite; and, 62.5±5 mg/L of the second kind of ammonium ions is reduced to 58±5 mg/L and is transformed into 0.245±0.02 mg/L of nitrate and 2.5±0.2 mg/L of nitrite.

For the two different kinds of ammonium ions, oxidation does not happen if the photocatalyst and the UV light do not co-exist; that is, no nitrite and no nitrate are obtained. Thus, the spin-disk active photocatalytic reactor is used to rapidly oxidize ammonium ions in water into nitrate and nitrite. The active photocatalytic reactor further controls a ratio of nitrate to nitrite. Nitrate is usually an intermediate product on fully oxidizing ammonium ions into nitrite. The ratio of nitrate to nitrite can be maintained between 7 and 10. Because nitrate is more toxic to aqua-livings, high efficiency on oxidizing nitrate into nitrite confirms reduction of toxicity of a culturing environment and further maintains stability of environment.

The present invention has the following advantages:

1. The present invention has a short start-up time, where waiting time for culturing is short and environment does not strongly affect capability of photocatalyst.

2. The present invention has a short response time, where sudden change in quality of culturing water can be handled to avoid damage.

3. The present invention can be coordinated with a test-and-feedback control system, where operative parameters of the active photocatalytic reactor can be adjusted for processing culturing water under different pollution rates.

4. The present invention uses the active photocatalytic reactor for reducing pollutant in culturing water, where function of the reactor is not limit by the photocatalyst used in the reactor and the light source used for activating the photocatalyst. Thus, materials which can be reduced or transformed by various photocatalytic reactions are reduced.

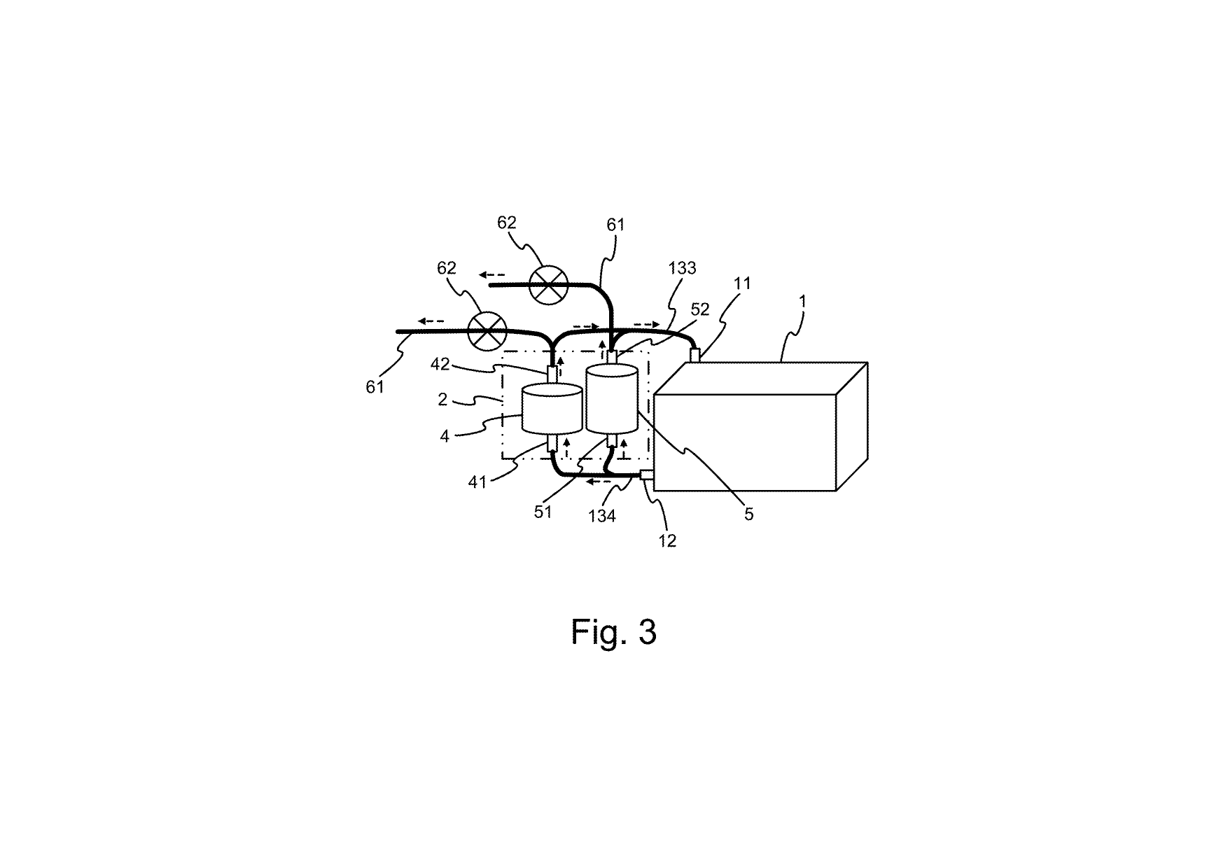

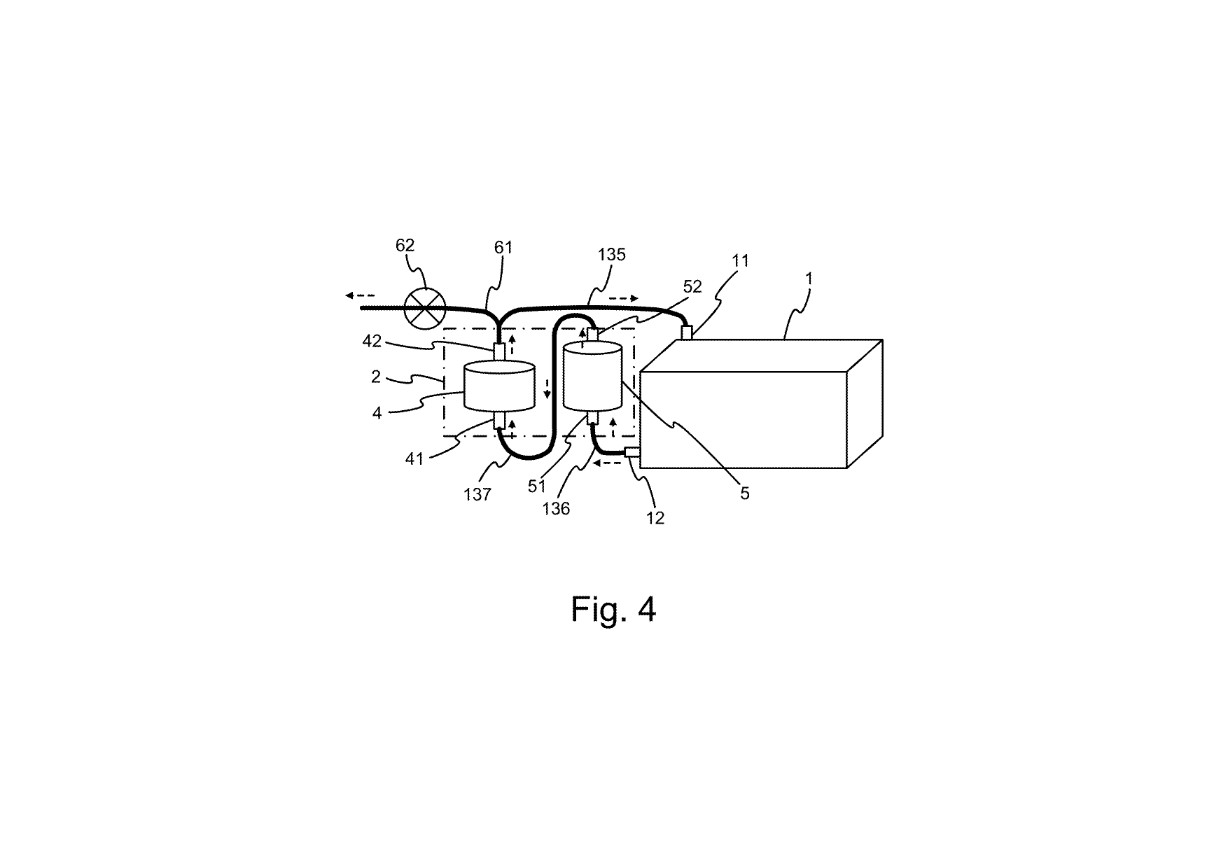

Please further refer to FIG. 3 and FIG. 4, which are views showing a second and a third preferred embodiment. As shown in the figures, the culturing-water waste reduction system 2 contains the active photocatalytic reactor 4, where, if necessary, a water filter 5 can be added under a parallel connection or a serial connection for forming a more stable and less interfered system.

In FIG. 3, the water filter 5 is combined between the biological culturing system 1 and the active photocatalytic reactor 4, where the water filter 5 has a water filter inlet 51 and a water filter outlet 52; the culture system inlet 11 is connected with the photocatalytic reactor outlet 42 and the water filter outlet 52 through a third cycling route 133; the culture system outlet 12 is connected with the photocatalytic reactor inlet 41 and the water filter inlet 51 through a fourth cycling route 134; a parallel connection is thus formed with the biological culturing system 1, the active photocatalytic reactor 4 and the water filter 5; and, the photocatalytic reactor outlet 42 and the water filter outlet 52 are separately connected with draining tubes 61 each having a control valve 62. Thus, the water filter 5 can be used to purify the culturing water.

In FIG. 4, the water filter 5 is combined between the biological culturing system 1 and the active photocatalytic reactor 4, where the water filter 5 has a water filter inlet 51 and a water filter outlet 52; the culture system inlet 11 is connected with the photocatalytic reactor outlet 42 through a fifth cycling route 135; the culture system outlet 12 is connected with the water filter inlet 51 through a sixth cycling route 136; the photocatalytic reactor inlet 41 is connected with water filter outlet 52 through a seventh cycling route 137; a serial connection is thus formed with the biological culturing system 1, the active photocatalytic reactor 4 and the water filter 5; and, the photocatalytic reactor outlet 42 is connected with a draining tube 61 having a control valve 62. Thus, the water filter 5 can be used to purify the culturing water.

Nevertheless, the present invention can be added with systems for temperature control, humidity control, auto-feeding in biological culturing system, etc. according to requirements.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of processing biological culturing water by using an active photocatalytic reactor,
wherein said method uses an apparatus comprising a biological culturing system and a culturing-water waste reduction system connected with said biological culturing system;
wherein said culturing-water waste reduction system contains an active photocatalytic reactor;
wherein culturing water is inputted into said active photocatalytic reactor of said culturing-water waste reduction system to purify a material in said culturing water;
wherein said material is a compound or a combination of said compounds and said compound is selected from a group consisting of NH₄, NH₃, NH₂ and NH; and
wherein, after purifying said culturing water, said culturing water is recycled to be outputted to said active photocatalytic reactor.

2. The method according to claim 1,
wherein said biological culturing system has a culture system inlet and a culture system outlet;
wherein said active photocatalytic reactor has a photocatalytic reactor inlet and a photocatalytic reactor outlet;
wherein said culture system inlet is connected with said photocatalytic reactor outlet through a first cycling route; and
wherein said culture system outlet is connected with said photocatalytic reactor inlet through a second cycling route.

3. The method according to claim 2,
wherein said photocatalytic reactor outlet is connected with a draining tube having a control valve.

4. The method according to claim 2,
wherein a water filter is further combined between said biological culturing system and said active photocatalytic reactor and said water filter has a water filter inlet and a water filter outlet; and
wherein said culture system inlet is connected with said photocatalytic reactor outlet and said water filter outlet through a third cycling route; said culture system outlet is connected with said photocatalytic reactor inlet and said water filter inlet through a fourth cycling route; and a parallel connection is thus obtained with said biological culturing system, said active photocatalytic reactor and said water filter.

5. The method according to claim 4,
wherein said photocatalytic reactor outlet and said water filter outlet are separately connected with draining tubes each having a control valve.

6. The method according to claim 2,
wherein a water filter is further combined between said biological culturing system and said active photocatalytic reactor and said water filter has a water filter inlet and a water filter outlet; and
wherein said culture system inlet is connected with said photocatalytic reactor outlet through a fifth cycling route; said culture system outlet is connected with said water filter inlet through a sixth cycling route; said photocatalytic reactor inlet is connected with said water filter outlet through a seventh cycling route; and a serial connection is thus obtained with said biological culturing system, said active photocatalytic reactor and said water filter.

7. The method according to claim 6,
wherein said photocatalytic reactor outlet is connected with a draining tube having a control valve.

8. The method according to claim 1,
wherein said culturing water has a pH value between 6 and 8.
